(19) United States
(12) Patent Application Publication
(10) Pub. No.: US 2021/0188326 A1
(43) Pub. Date: Jun. 24, 2021

(54) SYSTEM, UNIT, AND INFORMATION PROCESSING DEVICE

(71) Applicant: TOYOTA JIDOSHA KABUSHIKI KAISHA, Toyota-shi (JP)

(72) Inventors: Takahiro HARADA, Chiryu-shi (JP); Teppei NISHIGUCHI, Nisshin-shi (JP); Kazuki KOMORIYA, Toyota-shi (JP); Tomoaki IHARA, Toyota-shi (JP); Miyu HIGASHIMURA, Toyota-shi (JP); Toshihiro NAKAICHI, Nagoya-shi (JP); Kazunobu OKASAKA, Toyota-shi (JP); Ryo HATTORI, Kariya-shi (JP); Yohei TANIGAWA, Toyota-shi (JP); Ryohei KIMBARA, Toyota-shi (JP); Hiroshi NAKAMURA, Nagoya-shi (JP)

(73) Assignee: TOYOTA JIDOSHA KABUSHIKI KAISHA, Toyota-shi (JP)

(21) Appl. No.: 17/086,522

(22) Filed: Nov. 2, 2020

(30) Foreign Application Priority Data
Dec. 23, 2019 (JP) 2019-231686

(51) Int. Cl. B60W 60/00; G05D 1/02

(52) U.S. Cl. CPC B60W 60/00256; G05D 1/0212; B60P 3/007; B60W 60/00253; G05D 1/0276

(57) ABSTRACT

A system includes a vehicle, a unit separably connected to or mounted on the vehicle and configured to have a space to accommodate a person or a package and have a function of autonomously traveling within a predetermined area, and an information processing device configured to generate traveling command information for allowing the unit separated from the vehicle to travel to a destination within the predetermined area determined according to the person or the package accommodated in the unit when the vehicle is within the predetermined area and transmit the generated traveling command information to the unit.

### CROSS-REFERENCE TO RELATED APPLICATION

This application claims priority to Japanese Patent Application No. 2019-231686 filed on Dec. 23, 2019, incorporated herein by reference in its entirety.

### BACKGROUND

### 1. Technical Field

The present disclosure relates to a system, a unit, and an information processing device that are used for transportation of a person or a package to a destination.

### 2. Description of Related Art

DE 10 2009 057 693 A1 discloses a vehicle in which a unit having a drive unit can be separated.

### SUMMARY

The present disclosure provides a system, a unit, and an information processing device that efficiently perform transportation of a person or a package to a destination.

A first aspect of the present disclosure relates to a system. The system includes a vehicle, a unit, and an information processing device. The unit is separably connected to or mounted on the vehicle and is configured to have a space to accommodate a person or a package and have a function of autonomously traveling within a predetermined area. The information processing device is configured to generate traveling command information for allowing the unit separated from the vehicle to travel to a destination within the predetermined area determined according to the person or the package accommodated in the unit when the vehicle is within the predetermined area and transmit the generated traveling command information to the unit.

A second aspect of the present disclosure relates to a unit that is configured to have a space to accommodate a person or a package and is separably connected to or mounted on a vehicle. The unit includes a drive unit, a communication unit, and a controller. The drive unit is configured to make the unit in a state separated from the vehicle travel. The communication unit is configured to receive traveling command information for allowing the unit in the state separated from the vehicle to autonomously travel to a destination within the predetermined area determined according to the person or the package accommodated in the space from an information processing device. The controller is configured to control the drive unit based on the traveling command information within the predetermined area.

A third aspect of the present disclosure relates to an information processing device that manages traveling of a unit having a function of autonomously traveling within a predetermined area. The unit is separably connected to or mounted on a vehicle and is configured to have a space to accommodate a person or a package. The information processing device includes a controller. The controller is configured to acquire a destination within the predetermined area determined according to the person or the package accommodated in the unit, generate traveling command information for allowing the unit separated from the vehicle to travel to the destination within the predetermined area, and transmit the traveling command information to the unit.

According to the present disclosure, it is possible to efficiently perform transportation of a person or a package to a destination.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing the schematic configuration of a transportation system;

FIG. 2 is a diagram showing an example of a state in which a plurality of separable units is attached to a vehicle;

FIG. 3 is a diagram showing an example of a state in which the separable units are separated from the vehicle;

FIG. 4 is a block diagram schematically showing an example of the functional configuration of the separable unit;

FIG. 5 is a block diagram schematically showing an example of the functional configuration of a traveling management server;

FIG. 6 is a diagram showing an example of map information in a predetermined area;

FIG. 7 is a flowchart showing a flow of route generation processing;

FIG. 8 is a flowchart showing a flow of control information transmission processing; and

FIG. 9 is a diagram showing an example of a state in which the separable units are mounted on the vehicle and a state in which the separable units are separated from the vehicle.

### DETAILED DESCRIPTION OF EMBODIMENTS

The system according to the first aspect of the present disclosure is the system including the vehicle, the unit, and the information processing device. The unit is separably connected to or mounted on the vehicle. The unit is configured to have a space to accommodate a person or a package. The unit is configured to have a function of autonomously traveling within a predetermined area. The unit is separated from the vehicle when the vehicle is within the predetermined area.

The controller in the information processing device is configured to generate traveling command information for allowing the unit separated from the vehicle within the predetermined area to travel to a destination within the predetermined area. Then, the controller is configured to transmit the generated traveling command information to the unit. Here, the destination is the destination that is determined according to the person or the package accommodated in the unit. In this case, the unit autonomously travels along a route from a position, at which the unit is separated from the vehicle, to the destination based on the traveling command information. With this, the person or the package is transported to the destination by the unit within the predetermined area.

With the system in the present disclosure, it is possible to transport the person or the package accommodated in the unit from outside of the predetermined area to inside of the predetermined area by the vehicle. Then, the unit is separated from the vehicle and autonomously travels to the destination within the predetermined area. With this, it is possible to transport the person or the package transported to inside of the predetermined area by the vehicle in a state accommodated in the unit to the destination within the predetermined area without causing unboarding or unloading from the unit. Accordingly, it is possible to transport the person or the package from outside of the predetermined area to the destination within the predetermined area by the vehicle and the unit in a seamless manner. For this reason, it is possible to efficiently perform transportation of the person or the package to the destination.

Hereinafter, a specific embodiment of the present disclosure will be described referring to the drawings. The dimensions, materials, shapes, relative arrangements, and the like of components described in the embodiment are not intended to limit the scope of the present disclosure to these alone in particular as long as there are no specific statements.

### First Embodiment

Outline of System

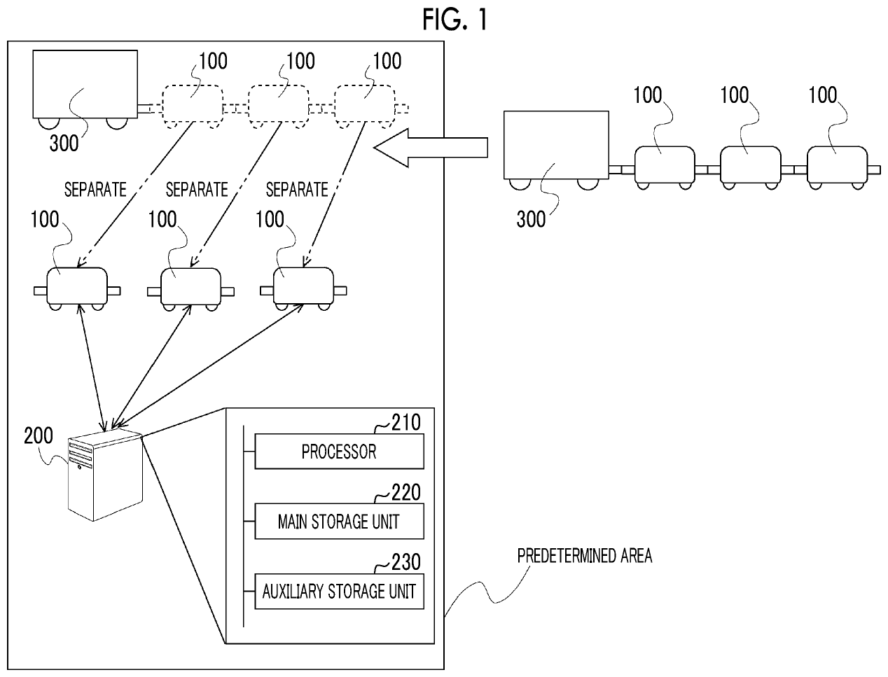

A transportation system 1 in the embodiment will be described referring to FIG. 1. FIG. 1 is a diagram showing the schematic configuration of the transportation system 1. The transportation system 1 includes a plurality of separable units 100, a traveling management server 200, and a vehicle 300. Here, the vehicle 300 is a vehicle having a function of autonomously traveling. Each of the separable units 100 has a space that accommodates a package. The separable unit 100 has a function of autonomously traveling within a predetermined area. Here, as the predetermined area, a site at a predetermined station, an airport, a port, a warehouse, or the like is exemplified. The package accommodated in the separable unit 100 is a package to be carried to a destination within the predetermined area. Here, the destination is a point within the predetermined area that is determined according to the package accommodated in the separable unit 100. As the destination, transportation equipment, such as a train, an airplane, or a ship, for transporting the package accommodated in the separable unit 100 to a place different from the predetermined area is exemplified. As the destination, a facility or the like where the package accommodated in the separable unit 100 is stored is also exemplified.

The vehicle 300 travels in a state connected to one separable unit 100 or attached to the separable units 100. In this case, the vehicle 300 travels while pulling one or the separable units 100. In FIG. 1, a case where the vehicle 300 pulls three separable units 100 is shown. Then, the vehicle 300 enters the predetermined area from outside of the predetermined area while pulling the separable units 100 to inside of the predetermined area. In this case, the vehicle 300 travels on a public road outside the predetermined area. That is, the vehicle 300 has a function of autonomously traveling even outside the predetermined area unlike the separable units 100. Then, when the vehicle 300 is within the predetermined area, each separable unit 100 is separated from the vehicle 300. The separable unit 100 is separated from the vehicle 300 to be brought into a state of autonomously traveling within the predetermined area.

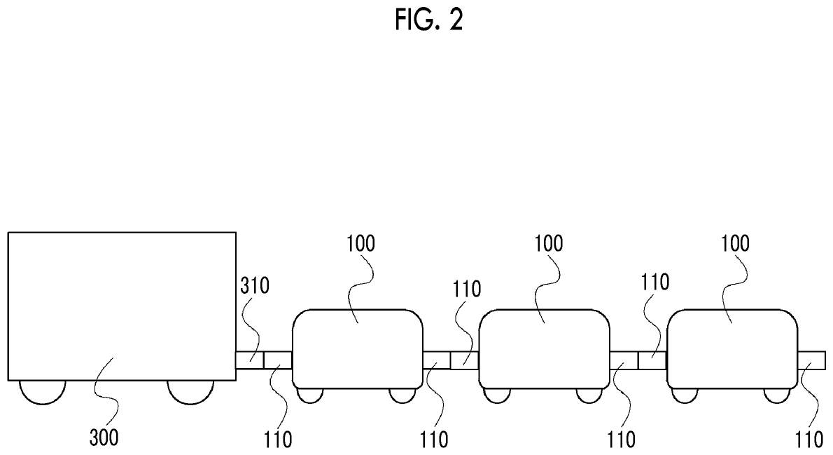

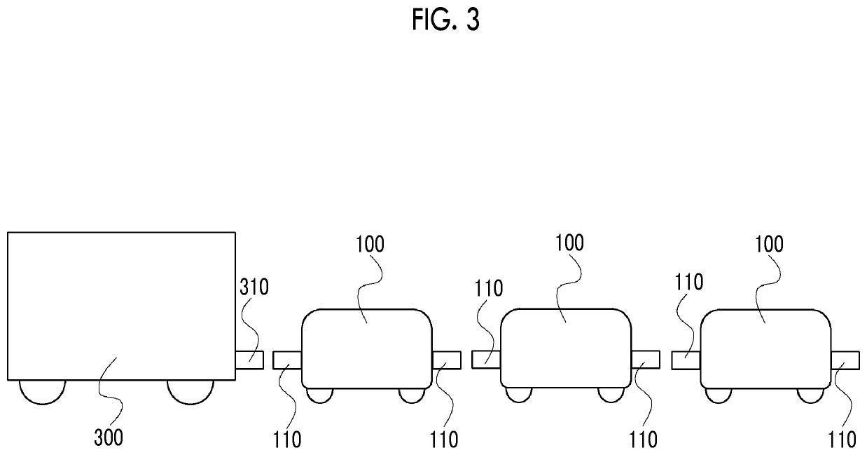

FIG. 2 is a diagram showing an example of a state in which the separable units 100 is attached to the vehicle 300. FIG. 3 is a diagram showing an example of a state in which the separable units 100 are separated from the vehicle 300. As shown in FIG. 2, the vehicle 300 includes a connection portion 310. Each of the separable units 100 includes connection portions 110. Then, the connection portion 310 of the vehicle 300 and the connection portion 110 of the separable unit 100 are connected to each other, whereby the vehicle 300 and the separable unit 100 are connected. The connection portions 110 of the two separable units 100 are connected to each other, whereby the separable units 100 are connected. With this, the separable units 100 can be attached to the vehicle 300. As shown in FIG. 3, the connection portions 310, 110 are disconnected, whereby the separable unit 100 is separated from the vehicle 300, and the separable units 100 are also separated. Then, the separable unit 100 autonomously travels to the destination after separated from the vehicle 300.

The structures of the connection portions 310, 110 are not particularly limited, and may be a structure in which the connection portions can be connected and separated. For example, as the structures of the connection portions 310, 110, a structure in which the connection portions are connected by bolts or a structure in which the connection portions are connected by magnetic force of electromagnets can be used.

The traveling management server 200 shown in FIG. 1 is a server that manages autonomous traveling of each of the separable units 100 within the predetermined area. The traveling management server 200 transmits control information for controlling the drive of the separable unit 100 to the separable unit 100, thereby managing autonomous traveling of the separable unit 100.

The traveling management server 200 includes a computer having a processor 210, a main storage unit 220, and an auxiliary storage unit 230. The processor 210 is, for example, a central processing unit (CPU) or a digital signal processor (DSP). The main storage unit 220 is, for example, a random access memory (RAM). The auxiliary storage unit 230 is, for example, a read only memory (ROM). The auxiliary storage unit 230 is, for example, a hard disk drive (HDD) or a disc recording medium, such as a CD-ROM, a DVD, or a Blu-ray disc. The auxiliary storage unit 230 may be a removable medium (portable storage medium). Here, as the removable medium, for example, a USB memory or an SD card is exemplified.

In the traveling management server 200, the auxiliary storage unit 230 stores an operating system (OS), various programs, various information tables, and the like. In the traveling management server 200, various functions described below can be implemented by the processor 210 loading the programs stored in the auxiliary storage unit 230 on the main storage unit 220 and executing the programs. However, a part or all of functions in the traveling management server 200 may be implemented by a hardware circuit, such as an ASIC or an FPGA. The traveling management server 200 may not always be implemented by a single physical configuration and may be constituted of a plurality of computers that cooperates with one another.

In the transportation system 1 shown in FIG. 1, the separable units 100 and the traveling management server 200 perform transmission and reception of various kinds of data including control information using a network (hereinafter, referred to as an “intra-area network”) constructed within the predetermined area. The traveling management server 200 is provided within the predetermined area and is connected to the intra-area network in a wired or wireless manner. The separable units 100 are connected to the intra-area network in a wireless manner. In this case, a range where radio waves for connection to the intra-area network reach is restricted within the predetermined area. For this reason, a range where the separable units 100 are connectable to the intra-area network is restricted within the predetermined area. With this, solely when the separable units 100 are within the predetermined area, transmission and reception of data between the separable units 100 and the traveling management server 200 can be performed. For this reason, the traveling management server 200 can manage autonomous traveling of the separable units 100 solely when the separable units 100 are within the predetermined area.

As described above, the vehicle 300 autonomously travels from outside the predetermined area to inside of the predetermined area while pulling the separable units 100. That is, the vehicle 300 is a vehicle that has an autonomous driving level to travel outside the predetermined area including the public road. On the other hand, each of the separable units 100 does not travel outside the predetermined area and autonomously travels within the predetermined area after separated from the vehicle 300 unlike the vehicle 300. That is, the separable unit 100 has an autonomous driving level to restrain autonomous traveling outside the predetermined area and to autonomously travel solely within the predetermined area. In this way, since the separable unit 100 has a traveling range restricted within the predetermined area, the autonomous driving level of the separable unit 100 becomes a level lower than the autonomous driving level to autonomously travel on the public road.

In the embodiment, the separable unit 100 travels with supply of electricity from a battery mounted in the separable unit 100. As described above, in the system according to the embodiment, the traveling range of the separable unit 100 is restricted within the predetermined area. For this reason, it is possible to reduce the capacity of the battery, or the like for use in making the separable unit 100 travel compared to a case where the separable unit 100 is not restricted within the predetermined area and travels even outside the predetermined area. Accordingly, it is possible to manufacture the separable unit 100 at low cost.

System Configuration

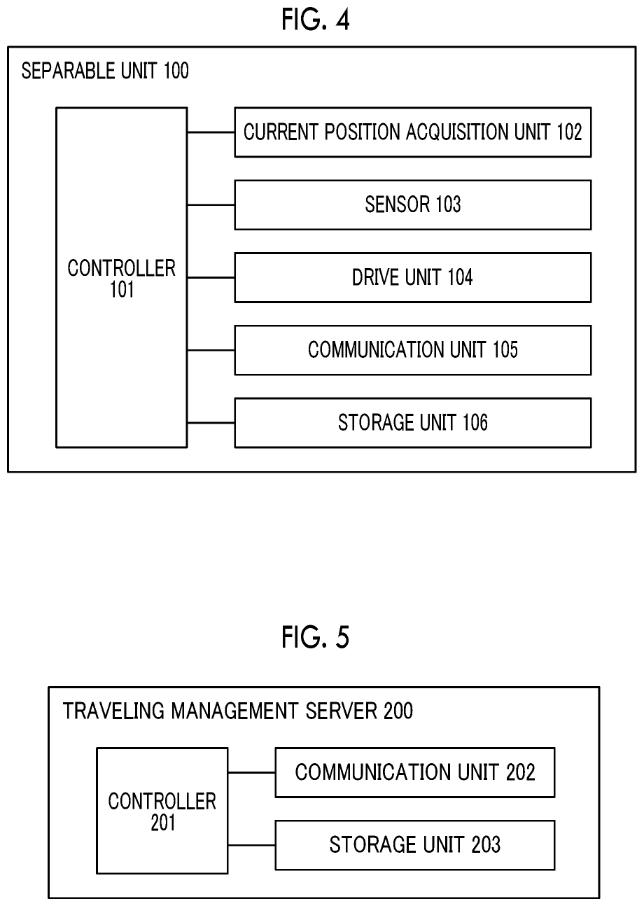

Next, the functional configurations of the separable unit 100 and the traveling management server 200 constituting the transportation system 1 in the embodiment will be described referring to FIGS. 4 and 5, respectively.

Separable Unit

FIG. 4 is a block diagram schematically showing an example of the functional configuration of the separable unit 100. As shown in FIG. 4, the separable unit 100 includes a controller 101, a current position acquisition unit 102, a sensor 103, a drive unit 104, a communication unit 105, and a storage unit 106.

The current position acquisition unit 102 is a device that acquires a current position of the separable unit 100. The current position acquisition unit 102 acquires the current position of the separable unit 100 in the predetermined area using a known method, such as GPS positioning, Wi-Fi (Registered Trademark) positioning, or beacon positioning.

The sensor 103 is a device that senses a situation around the separable unit 100. Specifically, the sensor 103 includes a stereo camera, a laser scanner, a LIDAR, a radar, or the like.

The drive unit 104 includes a motor that is a prime mover, and a mechanism (for example, an inverter, a brake, tires, and a steering mechanism) that makes the separable unit 100 travel. The drive unit 104 makes the separable unit 100 travel based on the control information transmitted from the traveling management server 200. Here, the control information includes information for controlling a rotation speed of the motor, information for controlling braking force of the brake, information for controlling a steering angle, and the like.

The communication unit 105 is a communication device that is provided for connection to the intra-area network. The communication unit 105 includes a wireless communication circuit for wireless communication. The separable unit 100 within the predetermined area can perform communication with the traveling management server 200 through the communication unit 105.

The storage unit 106 stores information (hereinafter, referred to as “destination information”) relating to a position of the destination. The storage unit 106 includes an auxiliary storage unit. The destination information includes an ID, coordinates, or the like for specifying the destination. Here, the coordinates may be a latitude and a longitude. The coordinates may be local coordinates in the predetermined area. The destination information is received from a terminal, a server, or the like which manages the package accommodated in the separable unit 100 by way of the communication unit 105, by the controller 101. The destination information may be directly input from an input unit provided in the separable unit 100. The destination information is stored in the storage unit 106 by the controller 101.

The controller 101 has a function of executing arithmetic processing for controlling the separable unit 100. The controller 101 includes a processor. The controller 101 generates current position information indicating a current position of the separable unit 100 based on positional information acquired by the current position acquisition unit 102.

The controller 101 transmits the destination information to the traveling management server 200 by way of the communication unit 105. The controller 101 transmits the current position information and information (hereinafter, referred to as “sensor information”) relating to the situation around the separable unit 100 acquired from the sensor 103 to the traveling management server 200. When the separable unit 100 is separated from the vehicle 300, the controller 101 transmits information (hereinafter, referred to as “separation information”) indicating the separation of the separable unit 100 from the vehicle 300 to the traveling management server 200 along with the current position information by way of the communication unit 105. The traveling management server 200 can ascertain that the separable unit 100 is in a state separated from the vehicle 300 based on the separation information. That is, the traveling management server 200 can ascertain that the separable unit 100 is in a state capable of autonomously traveling within the predetermined area. The controller 101 transmits the control information received from the traveling management server 200 to the drive unit 104 by way of the communication unit 105.

Traveling Management Server

FIG. 5 is a block diagram schematically showing an example of the functional configuration of the traveling management server 200. As shown in FIG. 5, the traveling management server 200 includes a controller 201, a communication unit 202, and a storage unit 203.

The communication unit 202 is a communication device that is provided for connection to the intra-area network. The communication unit 202 includes, for example, a local area network (LAN) interface board or a wireless communication circuit for wireless communication. The traveling management server 200 can perform communication with the separable units 100 within the predetermined area through the communication unit 202.

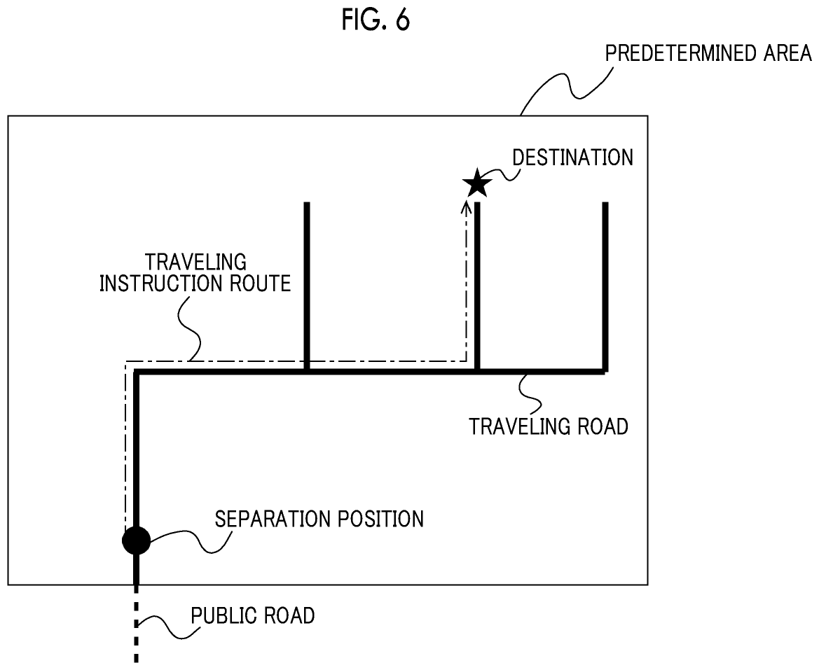

The storage unit 203 stores map information relating to a passage (hereinafter, referred to as a “traveling road”), through which the separable unit 100 can travel, in the predetermined area. The storage unit 203 can be implemented by the auxiliary storage unit 230. FIG. 6 is a diagram showing an example of the map information in the predetermined area. In the example shown in FIG. 6, a traveling road is shown by a bold line. A public road on which the vehicle 300 enters the predetermined area while pulling the separable units 100 is shown by a broken line. As shown in FIG. 6, the storage unit 203 stores map information of the traveling road. The traveling road may be a passage dedicated to the separable unit 100. The traveling road may be a passage through which another vehicle or a person can pass.

The controller 201 has a function of executing arithmetic processing for controlling the traveling management server 200. The controller 201 can be implemented by the processor 210. The controller 201 receives the destination information from the separable unit 100 by way of the communication unit 202. The controller 201 receives both of the separation information and the current position information from the separable unit 100 by way of the communication unit 202. The controller 201 acquires the position (hereinafter, referred to as a “separation position”), at which the separable unit 100 is separated from the vehicle 300, from the current position information received along with the separation information.

The controller 201 acquires the map information from the storage unit 203. With this, the controller 201 can ascertain the structure of the entire traveling road. Accordingly, the controller 201 generates a route (hereinafter, referred to as a “traveling instruction route”) from the separation position to the destination, along which the separable unit 100 is made to autonomously travel, based on the destination information, the map information, and the separation position. In the example shown in FIG. 6, the controller 201 generates a route from the separation position to the destination indicated by an arrow of a one-dot chain line as the traveling instruction route.

The controller 201 successively receives the current position information and the sensor information from the separable unit 100 by way of the communication unit 202. In this case, the controller 201 detects an environment around the separable unit 100 based on the sensor information. For example, the controller 201 detects an object, such as a person and another vehicle, around the separable unit 100. The controller 201 may track the detected object. In this case, the controller 201 may obtain a relative speed of the object, for example, from a difference between coordinates of the object detected before one step and current coordinates of the object. With this, the controller 201 can ascertain the environment around the separable unit 100. Accordingly, the controller 201 generates the control information for allowing the separable unit 100 to autonomously travel along the traveling instruction route based on the current position information and the sensor information. In this case, when an object with which the separable unit 100 is likely to collide is detected, the controller 201 may generate control information for avoiding collision with the object. The controller 201 transmits the generated control information to the separable unit 100 by way of the communication unit 202. With this, the separable unit 100 can autonomously travel along the traveling instruction route. In the embodiment, the control information corresponds to “traveling command information” according to the present disclosure.

Route Generation Processing

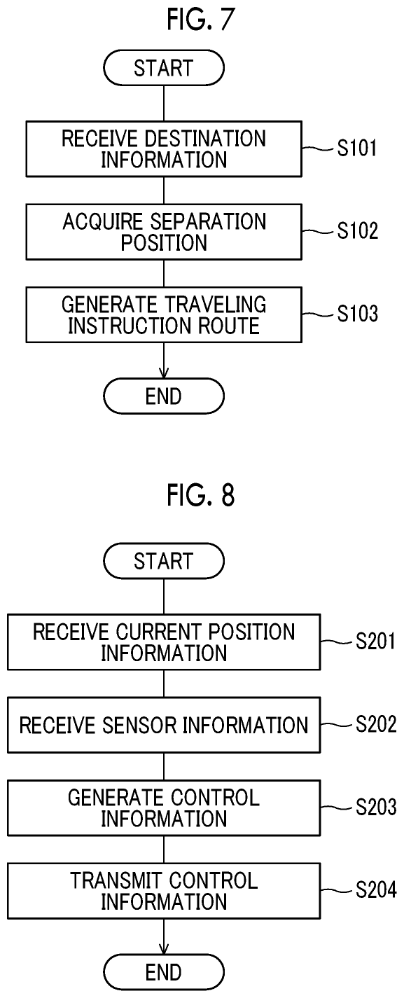

In the transportation system 1, route generation processing that is executed by the controller 201 in the traveling management server 200 will be described referring to FIG. 7. FIG. 7 is a flowchart showing a flow of the route generation processing. The route generation processing is processing of generating the traveling instruction route. In the route generation processing, first, in S101, the destination information is received from the separable unit 100. The destination information may not be received from the separable unit 100, and the destination information may be received from a server, a terminal, or the like that manages the destination. The destination information may be received from the vehicle 300 that acquires the destination information. Next, in S102, the separation position is acquired. Next, in S103, the traveling instruction route is generated.

Control Information Transmission Processing

Next, in the transportation system 1, control information transmission processing that is executed by the controller 201 in the traveling management server 200 will be described referring to FIG. 8. FIG. 8 is a flowchart showing a flow of the control information transmission processing. The control information transmission processing is processing of transmitting the control information to the separable unit 100 separated from the vehicle 300 within the predetermined area. The control information transmission processing is executed cyclically until the separable unit 100 arrives at the destination after the route generation processing is executed. In the control information transmission processing, first, in S201 and S202, the current position information and the sensor information are received. Next, in S203, the control information is generated. Then, in S204, the control information is transmitted to the separable unit 100.

As described above, with the transportation system 1 according to the embodiment, it is possible to transport the package accommodated in the separable unit 100 from outside of the predetermined area to inside of the predetermined area by the vehicle 300 first. Then, the separable unit 100 is separated from the vehicle 300 and autonomously travels to the destination within the predetermined area. With this, it is possible to transport the package transported to inside of the predetermined area by the vehicle 300 in a state accommodated in the separable unit 100 to the destination within the predetermined area without causing unloading from the separable unit 100. Accordingly, it is possible to transport the package from outside of the predetermined area to the destination within the predetermined area by the vehicle 300 and the separable unit 100 in a seamless manner. For this reason, it is possible to efficiently perform transportation of the package accommodated in the separable unit 100 to the destination.

The separable unit 100 may be a unit that has a space to accommodate a person. In this case, as the predetermined area, for example, a site at a predetermined station, an airport, a port, or the like is exemplified. As the destination, transportation equipment, such as a train, an airplane, or a ship, which is boarded by the person accommodated in the separable unit 100 is exemplified. As the destination, a boarding gate to the transportation equipment, such as a train, an airplane, or a ship, which is boarded by the person accommodated in the separable unit 100 is also exemplified.

Even in this case, similarly to when the package is accommodated in the separable unit 100, it is possible to transport the person accommodated in the separable unit 100 to the destination in a seamless manner. Accordingly, it is possible to efficiently move the person accommodated in the separable unit 100 to the destination.

The vehicle 300 may be a vehicle that is driven by a driver who boards the vehicle 300, not a vehicle that autonomously travels. The vehicle 300 may be a vehicle that can switch between an autonomous driving mode and a manual driving mode.

The traveling management server 200 may be provided outside the predetermined area. In this case, the separable units 100 and the traveling management server 200 are connected to each other through a network, for example, a wide area network (WAN) that is a worldwide public communication network, such as the Internet, or a telephone communication network of a mobile phone or the like. With this, the traveling management server 200 provided outside the predetermined area and the separable units 100 can perform communication. In this case, the traveling management server 200 may start transmission and reception of data between each of the separable units 100 and the traveling management server 200 solely when information indicating that the current position of the separable unit 100 is within the predetermined area is received from the separable unit 100. Even with such a method, transmission and reception of data between the separable unit 100 and the traveling management server 200 can be performed solely when the separable unit 100 is within the predetermined area.

### Modification Examples

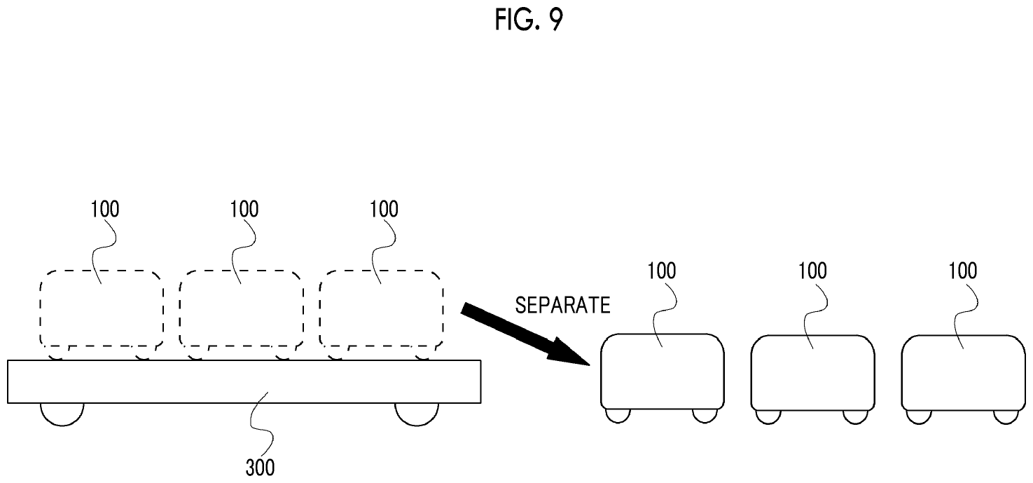

The form of the vehicle 300 and the separable units 100 in traveling outside the predetermined area are not limited to the form shown in FIG. 2 in which both are attached to each other. FIG. 9 is a diagram showing an example of a state in which separable units 100 are mounted on a vehicle 300 and a state in which the separable units 100 are separated from the vehicle 300. As shown in FIG. 9, the separable units 100 can be separated from the vehicle 300. Even in the example shown in FIG. 9, the vehicle 300 and the separable units 100 may have connection portions to be separably connected to each other.

### Second Embodiment

In the above-described first embodiment, the controller 201 in the traveling management server 200 generates the control information for the drive unit 104 in the separable unit 100. However, the separable unit 100 may perform the generation of the control information. In the second embodiment, the controller 101 of the separable unit 100 performs the generation of the control information for the drive unit 104.

System Configuration

The functional configurations of the separable unit 100 and the traveling management server 200 constituting the transportation system 1 in the embodiment will be described. As in the first embodiment, the controller 201 of the traveling management server 200 generates the traveling instruction route based on the destination information, the map information, and the separation position. Then, the controller 201 transmits information (hereinafter, referred to as “route information”) indicating the traveling instruction route to the separable unit 100 by way of the communication unit 202. In the embodiment, the route information corresponds to “traveling command information” according to the present disclosure.

The controller 101 in the separable unit 100 detects the environment around the separable unit 100 based on the sensor information. Then, the controller 101 generates the control information for allowing the separable unit 100 to autonomously travel along the traveling instruction route based on the current position information and the sensor information. The controller 101 transmits the generated control information to the drive unit 104. With this, the separable unit 100 can autonomously travel along the traveling instruction route.

Route Information Transmission Processing

In the transportation system 1, route information transmission processing that is executed by the controller 201 in the traveling management server 200 will be described. The route information transmission processing is processing of transmitting the route information to the separable unit 100 separated from the vehicle 300 within the predetermined area. In the route information transmission processing, after the same processing as the processing of S101 to S103 in the route generation processing shown in FIG. 7, the route information is transmitted to the separable unit 100.

As described above, even in the second embodiment, as in the first embodiment, it is possible to efficiently perform transportation of the person or the package to the destination by the separable unit 100.

The traveling management server 200 may transmit the map information within the predetermined area to the separable unit 100, instead of the route information. In this case, the controller 101 of the separable unit 100 acquires the destination information and generates a route from the separation position to the destination, along which the separable unit 100 is made to autonomously travel, based on the destination information, the map information, and the separation position. Then, the controller 101 generates the control information for autonomous traveling from the separation position to the destination. Even in this case, the separable unit 100 can autonomously travel from the separation position to the destination.

### Other Embodiments

The above-described embodiments are just examples, and the present disclosure may be appropriately modified and carried out without departing from the spirit and scope of the present disclosure. The processing or units described in the present disclosure can be freely combined and implemented as long as no technical contradiction arises.

Processing described to be executed by one device may be shared and executed by a plurality of devices. Alternatively, processing described to be executed by different devices may be executed by one device. In a computer system, a hardware configuration (server configuration) that implements each function may be flexibly changed.

The present disclosure may also be implemented by supplying a computer program mounted with the functions described in the above-described embodiments to a computer and causing one or more processors in the computer to read and execute the program. Such a computer program may be provided to the computer by a non-transitory computer-readable storage medium connectable to a system bus of the computer or may be provided to the computer through a network. The non-transitory computer-readable storage medium includes, for example, any type of disk, such as a magnetic disk (a Floppy (Registered Trademark) disk, a hard disk drive (HDD), or the like), or an optical disc (a CD-ROM, a DVD, a Blu-ray disc, or the like), a read only memory (ROM), a random access memory (RAM), an EPROM, an EEPROM, a magnetic card, a flash memory, an optical card, or any type of medium suitable for storing electronic instructions.

What is claimed is:

1. A system comprising:
a vehicle;
a unit separably connected to or mounted on the vehicle and configured to have a space to accommodate a person or a package and have a function of autonomously traveling within a predetermined area; and
an information processing device configured to generate traveling command information for allowing the unit separated from the vehicle to travel to a destination within the predetermined area determined according to the person or the package accommodated in the unit when the vehicle is within the predetermined area and transmit the generated traveling command information to the unit.

2. The system according to claim 1, wherein the traveling command information is control information that is transmitted to the unit during a period until the unit arrives at the destination from a position separated from the vehicle and controls drive of the unit.

3. The system according to claim 1, wherein the traveling command information is route information including a route that is a route from a position, at which the unit is separated from the vehicle, to the destination, and along which the unit autonomously travels.

4. The system according to claim 1, wherein:
the predetermined area is a site at a station, a port, an airport, or a warehouse; and
the destination is transportation equipment, which transports the package accommodated in the unit or a facility, which stores the package accommodated in the unit, within the predetermined area.

5. The system according to claim 1, wherein:
the predetermined area is a site at a station, a port, or an airport; and
the destination is transportation equipment, on which the person accommodated in the unit boards, or a boarding gate to the transportation equipment, on which the person accommodated in the unit boards, within the predetermined area.

6. The system according to claim 1, wherein transmission and reception of data are possible between the unit and the information processing device solely when the unit is within the predetermined area.

7. The system according to claim 1, wherein the unit has connection portions that are connectable to the vehicle, and are connectable to other units when a plurality of the units is connected to the vehicle.

8. A unit that is configured to have a space to accommodate a person or a package and is separably connected to or mounted on a vehicle, the unit comprising:
a drive unit configured to make the unit in a state separated from the vehicle travel;
a communication unit configured to receive traveling command information for allowing the unit in the state separated from the vehicle to autonomously travel to a destination within the predetermined area determined according to the person or the package accommodated in the space from an information processing device; and
a controller configured to control the drive unit based on the traveling command information within the predetermined area.

9. The unit according to claim 8, wherein the traveling command information is control information that is transmitted to the unit during a period until the unit arrives at the destination from a position separated from the vehicle and controls drive of the unit.

10. The unit according to claim 8, wherein the traveling command information is route information including a route that is a route from a position, at which the unit is separated from the vehicle, to the destination, and along which the unit autonomously travels.

11. The unit according to claim 8, wherein:
the predetermined area is a site at a station, a port, an airport, or a warehouse; and
the destination is transportation equipment, which transports the package accommodated in the unit or a facility, which stores the package accommodated in the unit, within the predetermined area.

12. The unit according to claim 8, wherein:
the predetermined area is a site at a station, a port, or an airport; and
the destination is transportation equipment, on which the person accommodated in the unit boards, or a boarding gate to the transportation equipment, on which the person accommodated in the unit boards, within the predetermined area.

13. The unit according to claim 8, wherein transmission and reception of data to and from the information processing device are possible solely when the unit is within the predetermined area.

14. The unit according to claim 8, wherein the unit has connection portions that are connectable to the vehicle, and are connectable to other units when a plurality of the units is connected to the vehicle.

15. An information processing device that manages traveling of a unit having a function of autonomously traveling within a predetermined area, in which the unit is separably connected to or mounted on a vehicle and is configured to have a space to accommodate a person or a package, the information processing device comprising a controller configured to
acquire a destination within the predetermined area determined according to the person or the package accommodated in the unit,
generate traveling command information for allowing the unit separated from the vehicle to travel to the destination within the predetermined area, and
transmit the traveling command information to the unit.

16. The information processing device according to claim 15, wherein the traveling command information is control information that is transmitted to the unit during a period until the unit arrives at the destination from a position separated from the vehicle and controls drive of the unit.

17. The information processing device according to claim 15, wherein the traveling command information is route information including a route that is a route from a position, at which the unit is separated from the vehicle, to the destination, and along which the unit autonomously travels.

18. The information processing device according to claim 15, wherein:
the predetermined area is a site at a station, a port, an airport, or a warehouse; and
the destination is transportation equipment, which transports the package accommodated in the unit or a facility, which stores the package accommodated in the unit, within the predetermined area.

19. The information processing device according to claim 15, wherein:
the predetermined area is a site at a station, a port, or an airport; and
the destination is transportation equipment, on which the person accommodated in the unit boards, or a boarding gate to the transportation equipment, on which the person accommodated in the unit boards, within the predetermined area.

20. The information processing device according to claim 15, wherein transmission and reception of data to and from the unit are possible solely when the unit is within the predetermined area.
